(19) United States
(12) Patent Application Publication
(10) Pub. No.: US 2019/0358790 A1
(43) Pub. Date: Nov. 28, 2019

(54) Flexible Wrench

(71) Applicant: Linlin Weng, Yangzhou (CN)

(72) Inventor: Linlin Weng, Yangzhou (CN)

(73) Assignee: Jiangsu Sainty International Group Jiangdu Tools Co, Ltd

(21) Appl. No.: 15/988,800

(22) Filed: May 24, 2018

(51) Int. Cl. B25B 23/00; B25B 13/46

(52) U.S. Cl. CPC B25B 23/0028; B25B 13/462

(57) ABSTRACT

A flexible wrench with an independent and separate wrench handle and an independent and separate wrench head. The wrench head is mounted to the wrench handle with a press-button locking mechanism having a pre-compressed spring that requires pressing both ends of the locking mechanism to release the locking position, improving safety to a user.

### DESCRIPTION OF RELATED ART

The present application relates to a wrench, more particularly, to a flexible wrench that has a geared connector flexible and adjustable between the wrench head and the wrench body so that the position of the wrench body in relation to the wrench head is flexible, allowing the wrench to operate at an angle in order to reach nuts and bolts in places that are hard to reach.

Note that the points discussed below may reflect the hindsight gained from the disclosed inventions, and are not necessarily admitted to be prior art.

There are many types of wrenches. They include a wrench head and a wrench body, the wrench head is generally for griping objects, and the wrench body is for applying torque force to move the objects. The mechanical designs of the wrench heads can categorize wrenches into different types and sub-types. A wrench head may involve complicated head designs for special purposes and uses. Many wrench head may include additional adapters to enhance the strength of gripping force; and for the same reason, the connection between the wrench head and the wrench body is often manufactured into one single piece with no flexibility.

However when an object is located in a crowded area, there may be insufficient free space for the wrench head that is fixed on a large wrench body to clench the object. One solution lies in making the connection between the wrench head and the wrench body flexible. But flexibility in connection area can dramatically reduce the durability of a wrench.

There is a great need for novel wrench designs that can provide both flexibility and strength between the wrench body and the wrench head.

### SUMMARY

The present application discloses a new wrench design that includes a separate and independent wrench handle and a separate and independent wrench head locked together by a novel locking mechanism.

In one embodiment, a wrench comprises an assembly of a set of separate and independent wrench handle and wrench head. The wrench handle has an attachment end configured with axially extending two mirroring and internally teethed ring flanges whereas the wrench head also has an attachment end having an internally teethed opening that matches with the ring flanges of the wrench handle. The attachment end of the wrench head is configured to slide into the space between the two mirroring ring flanges so that they form a body with an internal teethed opening.

In one embodiment, a wrench comprises an assembly of a set of separate and independent wrench handle, wrench head and a wrench head connector. The wrench handle has an attachment end configured with axially extending two mirroring and internally teethed ring flanges whereas the wrench head connector has a handle attachment end for attaching the wrench handle, and a head mounting end for attaching the wrench head. The attachment end of the wrench head connector is configured with an internally teethed opening that matches with those of the two ring flanges of the wrench handle. The attachment end of the wrench head connector is configured to slide into the space between the two mirroring ring flanges so that they form a body with matching internal teeth.

In one aspect, the internal teeth of each of the two extending ring flanges of the wrench handle are constructed on a flange ring disposed on the peripheral wall inside the opening of the ring flange, the construct of the flange ring matches that of the attachment end of the wrench head or that of the attachment end of the wrench head connector in the alternative wrench head design.

In one aspect, a press button locking mechanism that contain an upper and a lower button caps is configured. The press button locking mechanism requires both the thumb and point fingers pressing the upper and the lower caps simultaneously to release its locking status. It comprises an upper externally teethed wheel and a lower externally teethed wheel that are mounted to the upper and lower caps respectively. The teeth constructions match with the internal teeth of the attachment ends of the wrench handle and the wrench head. Each of the wheels is attached to its respective cap so that a groove is formed between the cap and the wheel. The externally teethed wheels together with their caps are fitted into the openings of the ring flanges, a pre-compressed spring sits inside the openings and links the two wheels and the caps together.

At the locking position, the externally teethed wheels and the internally teethed flange rings bite together, the wrench handle and the wrench head are immobilized with each other. By pressing the button caps, the internally teethed flange rings will fit into the grooves between the caps and the wheels, allowing the wrench head (or the wrench connector) to rotate freely around the press buttons. Additionally a pair of lock rings may be fitted the wheels and the ring flanges. The pre-compressed spring between the button caps provides enhanced safety as it requires two fingers to press simultaneously in order to unlock the press button's locking position, a user is thus prevented from adjusting the wrench while still operating the wrench.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 shows a prior art of a fixed wrench.

FIG. 2 shows an example assembly set of a flexible wrench in accordance with this application.

FIG. 3 shows another example assembly set of a flexible wrench having a connector in accordance with this application.

FIG. 4 shows a cross-section view of an example locking button in accordance with this application.

FIG. 5 demonstrates a wrench adjustment at a horizontal parallel direction in relation to the plane of the wrench body and the wrench head in accordance with this application.

FIG. 6 demonstrates a wrench adjustment at a vertical direction in relation to the plane of the wrench body and the wrench head in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the following figures illustrate the general manner of construction, and description and details of well-known features and techniques that may be omitted to avoid unnecessarily obscuring the invention. Additionally, elements in the figures are not necessarily drawn to scale; some areas or elements may be expanded to help improve understanding of the embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The term “wrench” refers to a mechanical tool having a wrench handle for applying torque force and a wrench head for interacting with an object on a surface and the applied torque force will fasten or loosen the object on the surface.

The term “flexible wrench” refers to a mechanical tool having a separate and independent wrench handle and a separate and independent wrench head, and the wrench handle and the wrench head are mounted together through a flexible mechanism so that the relative position between the wrench handle and the wrench head is adjustable.

The term “wrench head connector” refers to a mechanical part that physically mounts a separate and independent wrench handle together with a separate and independent wrench head so that the wrench can function as a whole, and a torque force applied to the wrench handle can be transferred from the wrench handle to the wrench head to rotate an object.

The term “internally teethed” refers to a ring structure similar to an internal gear where the teeth are cut into an inside diameter while the outside diameter is kept smooth.

The term “externally teethed” refers to a structure similar to a spur gear where the teeth are cut into the surface of an outside diameter.

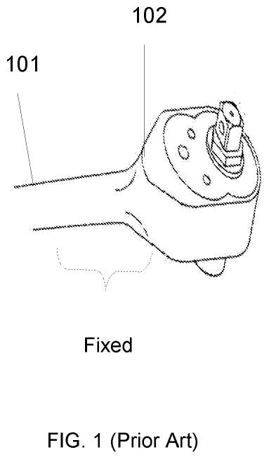

In reference to FIG. 1, a prior art wrench includes a wrench head 102, wrench handle 101, and wrench head 102 are directly molded together with the wrench handle 101, there is no flexibility between the wrench head and the wrench handle. The fixed construction of the wrench handle and the wrench head may not be able to clench onto an object that is located at a crowded area.

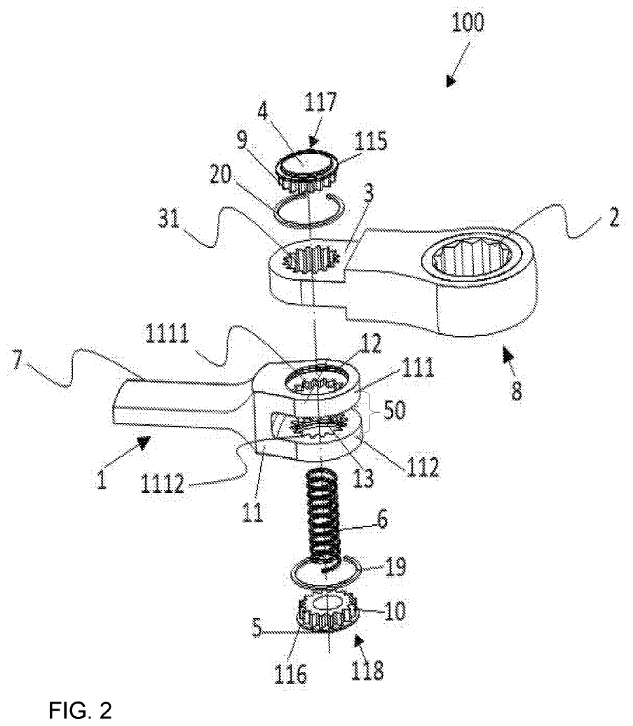

In reference to FIG. 2, a flexible wrench 100 includes an independent and separate wrench handle 1 and an independent and separate wrench head 8. Wrench handle 1 has an elongated handle body 7 for holding by a human hand or other tools to apply a torque force. The elongation provides a leverage to the torque force. Wrench head 8 is configured for interacting with an object that needs to be fastened or loosened. Wrench head 8 has an head end that is constructed according to a need in use and that may match the shape and the size of an object. For example, it may be shaped as a circular ring having internal teeth 2, or a box end, an open end or an adjustable end. Wrenches are often categorized according to their different wrench heads.

In FIG. 2, wrench handle 1 and wrench head 8 are configured with an attachment end (11 and 3 respectively) that interact with each other. Attachment end 11 of wrench handle 1 is constructed with axially extending two mirroring ring flanges 111 and 112. Flange 111 has a first opening, and flange 112 has a second opening. The center axis of each of the openings are in alignment and the flanges 111 and 112 are spaced apart in a predetermined distance that defines an open slot 50 in the handle attachment end 11.

Ring flanges 111 and 112 are further respectively configured with mirroring flange rings 1111 and 1112 within the first opening and the second opening. The flange ring 1111 is disposed at the bottom half of ring flange 111, forming a shoulder for receiving lock ring 20. The flange ring 1112 is disposed at the upper side of ring flange 112, in mirroring positions to flange ring 1111, forming a shoulder for receiving lock ring 19. Flange rings 1111 and 1112 each are constructed with plurality of internal teeth. The flange ring 111 and 112 may also contain threaded portions 12 and 13 in mirroring positions for receiving threaded press buttons 117 and 118.

Attachment end 3 of wrench head 8 is configured with a similar opening 31 constructed with a plurality of internal teeth that match with the construction of the internal teeth of ring flanges 111 and 112 in size and shape. The distance 50 between ring flanges 111 and 112 is configured to allow the fit-in of attachment end 3 of wrench head 8. Once attachment end 3 is fitted into slot 50, its opening 31 and its internal teeth will precisely match and align with the internal teeth construction of 1111 and 1112 of wrench handle 1 and form one integrally aligned and internally teethed opening for receiving an externally teethed wheels of a press button locking mechanism.

Flexible wrench 100 includes a separate and independent button locking mechanism for fixing and locking together wrench handle 1 and wrench head 8. The locking mechanism consists of a paired press buttons 117 and 118. Each press button is comprised of a cap 4 or 5, an externally teethed wheel 9 or 10 that is vertically attached to its respective cap along the cap's center axis. Wheels 9 and 10 are respectively constructed with plurality of external teeth, and the teeth construction match with the internal teeth construction of 1111 and 1112, as well as the teeth construction of opening 31 of attachment end of wrench head 8.

In assembly, cap 4, wheel 9, metal spring 6, ring flange 111, opening 31, ring flange 112, metal spring 6, wheel 10, and cap 5 are aligned in order and share the same center axis. Threaded ring 115 and 116 may be constructed to press button 117 and 118 to allow the press button to be threadedly mounted onto the threaded portion 12 and 13 of flange ring 111 and 112. Metal spring 6 is inserted into the openings of ring flange 111, opening 31, ring flange 112 to link wheel 9 of press button 117 with wheel 10 of press button 118. Metal spring 6 is in a compressed position when both press buttons 117 and 118 are mounted. When flexible wrench 100 is assembled, spring 6 is in slightly compressed position, slightly pushing press buttons 117 and 118 in opposite direction, while the teeth of wheel 9 and wheel 10 are engaged with both the teeth of 1111 and 1112 and the teeth of opening 31 of wrench head 8. When the teeth of wheels 9 and 10 engage with both the teeth of opening 31 and the teeth of wrench handle, with the enhancement of a lock ring, the press-buttons will fixedly lock the wrench handle and wrench head together.

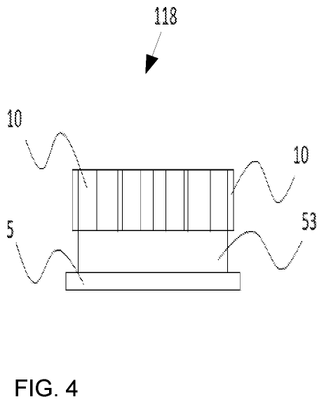

As shown in FIG. 4, a example press button 118 is shown. Press button 117 is similarly constructed (figure not shown). Between cap 5 and teethed wheel 10, a groove 53 is formed. Similar groove 52 is formed in press button 117 (figure not shown). When press-button 117 and press-button 118 are pressed simultaneously, caps 4 and 5 move towards each other, flange rings 1111 and 1112 slide into grooves 52 and 53 that have no teeth, allowing the teeth of attachment end 3 to disengage from flange rings 1111 and 1112 while remains engaged with wheels 9 and wheel 10 of press-buttons 117 and 118, attachment end 3 is released to rotate. By pressing on caps 4 and 5 again to further compress spring 6 and releasing the caps, the further compressed spring 6 will push wheels 9 and 10 away from each other with sufficient force and push flange rings 1111 and 1112 to slide out of grooves 52 and 53, and rendering the teeth of wheel 9 and wheel 10 become engaged with both the teeth of 1111 and 1112 and the teeth of opening 31 of wrench head 8 again, locking and fixing the wrench head 8 to the wrench handle 1.

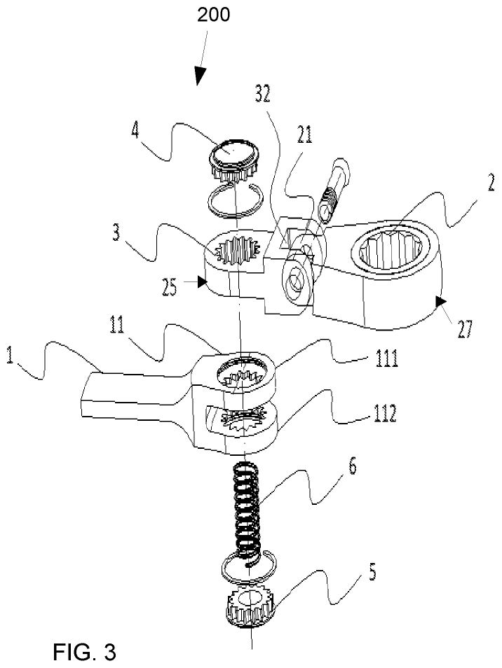

In reference FIG. 3, an alternative flexible wrench 200 is shown. Flexible wrench 200 includes a connector 25 that is configured with an attachment end 3 for interacting with wrench handle 1 and a connecting end 32 for interacting with a wrench head 27. The connecting end 32 may be designed to allow additional adjustment direction between the connector and wrench head in a different direction as to the adjustment direction between the wrench handle and the connector. For example, connecting end 32 may have two parallel ring flanges that form a slot 21 to allow wrench head 27 to adjust vertically while slot 50 allows the connector to adjust position horizontally. Alternatively, connecting end 32 may also be constructed similarly as to the structure of attachment end 3, or simply to have a bolting hole for the attachment of wrench head 27.

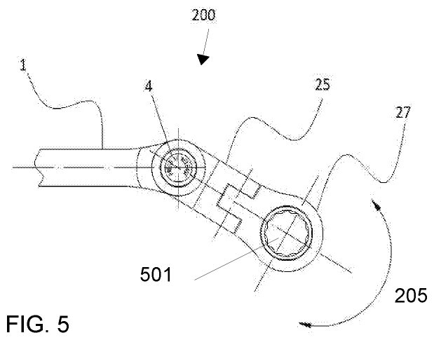

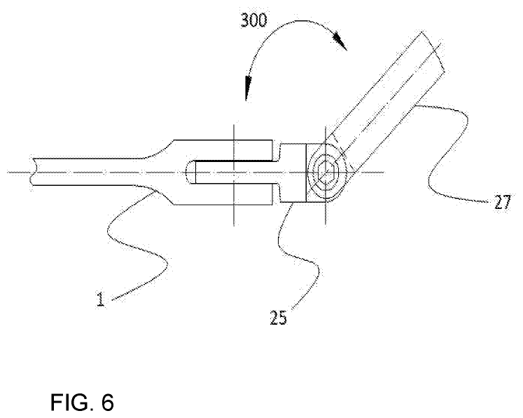

The press button locking mechanism and the attachment end 11 and attachment end 3 will allow for the adjustment of positioning of the wrench at the time of using while still attached to the object. This feature is very friendly. In reference to FIG. 5 and FIG. 6, the user friendliness in adjustment of the flexible wrench handle is demonstrated with a connector wrench 200 shown in FIG. 3. A connector flexible wrench 200 has clenched onto object 501. By simultaneously pressing down of caps 4 and 5 (not shown), connector 25 is released and allowed to rotate in the arrow direction 205 in the same plane of wrench handle 1 and wrench connector 25. Whereas, connector 25 with a construction shown in FIG. 3 will also allow the wrench head 27 to be adjusted at the direction 300 that is vertical to the plane of wrench handle 1 and the connector 25.

In order to enhance safety of use, under the locked and non-released condition, metal spring 6 is slightly compressed so that it requires two fingers to press cap 4 and cap 5 simultaneously in order to release the locking position. This improves the safety of the wrench because a user must stop operating the wrench in order to use two fingers to release the locking buttons, preventing accidents from happening in adjusting the wrench while operating the wrench. The wrench of all parts are made of durable metal, preferably steel.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A flexible wrench, comprising:
a separate and independent wrench handle having a first attachment end and an elongated handle for applying torque force, said first attachment end having an extending first flange and an extending second flange, said first flange and said second flange paralleling in forming a slot, said first flange having a first aperture and a first flange ring configured with a first set of internal teeth and said first flange ring being disposed within said first aperture, said second flange having a second aperture and a second flange ring configured with a second set of internal teeth and said second flange ring being disposed within said second aperture;
a separate and independent wrench head connector having a second attachment end and a wrench head end for interacting with an object or with a wrench head, said second attachment end having an extended third flange being disposed within said slot, said third flange having a third aperture, said third flange being internally teethed with a third set of internal teeth within said third aperture;
a press-button locking mechanism having a first cap attached with a first wheel in forming a first groove and a second cap attached with a second wheel in forming a second groove, said first wheel having a first set of external teeth that engage with both said first set of internal teeth within said first aperture and said third set of internal teeth within said third aperture, and said second wheel having a second set of external teeth that engage with both said second set of internal teeth within said second aperture and said third set of internal teeth within said third aperture; and
a spring being disposed simultaneously inside said first aperture, said third aperture and said second aperture, linking both said first wheel and said second wheel,
wherein said first cap, said first set of external teeth, said first set of internal teeth, said third set of internal teeth, said second set of internal teeth and said second set of external teeth, and said second cap are aligned in sequential order and along a common center axis, so that upon pressing said first cap and said second cap, said first set of internal teeth slide into said first groove and said second set of internal teeth slide into said second groove, each respectively disengages with said first set of external teeth and said second set of external teeth while said third said of internal teeth remain engaged with both said first set of external teeth and said second set of external teeth.

2. The flexible wrench of claim 1, wherein said wrench head end of said wrench connector is further configured with a pair of extending flanges vertical to the first flange and the second flange allowing another wrench head to be mounted.

3. The flexible wrench of claim 1, wherein said spring is pre-compressed at a locking position, said spring is compressed further to release the locking position.

4. A method of tightening or loosening an object on a surface, comprising the steps of:
providing a flexible wrench of claim 1,
clenching the object with the wrench head;
pressing simultaneously the first cap and the second cap to slide said first set of internal teeth into said first groove and said second set of internal teeth into said second groove;
rotating the wrench handle to adjust the wrench handle into a desired position; and
pressing and releasing simultaneously the first cap and the second cap to slide said first set of internal teeth out of said first groove and said second set of internal teeth out of said second groove to engage both the first set of external teeth with said first set of internal teeth and the second set of external teeth with said second set of internal teeth; and
applying a torque force to the wrench handle to tighten or loosen the object.

5. A method of tightening or loosening an object on a surface, comprising the steps of:
providing a flexible wrench of claim 2,
adjusting said wrench head to a vertical angle with said wrench handle;
clenching the object with the wrench head;
pressing simultaneously the first cap and the second cap to slide said first set of internal teeth into said first groove and said second set of internal teeth into said second groove;
rotating the wrench handle to adjust the wrench handle into a desired position; and
pressing and releasing simultaneously the first cap and the second cap to slide said first set of internal teeth out of said first groove and said second set of internal teeth out of said second groove to engage both the first set of external teeth with said first set of internal teeth and the second set of external teeth with said second set of internal teeth; and
applying a torque force to the wrench handle to tighten or loosen the object.
